(19) United States
(12) Patent Application Publication
(10) Pub. No.: US 2004/0109819 A1
(43) Pub. Date: Jun. 10, 2004

(54) Process for producing anhydrous alkali sulfide

(76) Inventors: Hans Christian Alt, Gelnhausen-Meerholz (DE); Andreas Golz, Rodenbach (DE); Alfred Alig, Geiselbach-Omersbach (DE)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/714,678

(22) Filed: Nov. 14, 2003

(30) Foreign Application Priority Data
Dec. 4, 2002 (DE) 102 56 530.9

(51) Int. Cl. C01B 17/22

(52) U.S. Cl. 423/566.2

(57) ABSTRACT

A process and a device for producing anhydrous alkali sulfide, wherein hydrous alkali sulfide is dried by fluidized bed spray granulation.

### BACKGROUND OF THE INVENTION

The present invention relates to a process for producing anhydrous alkali sulfide.

In the dry state and when finely dispersed, alkali sulfides can react with air at elevated temperature, giving rise to considerable potential risks and product losses during thermal drying. This represents a major processing and safety obstacle to the performance of such a process.

The production of anhydrous alkali sulfide by vacuum contact drying, starting from the solid containing water of crystallization, is known from EP 0 924 165 A1.

Furthermore, the convective spray drying of anhydrous alkali sulfides using hot, anhydrous inert gases, is known from WO 01/255146.

An overview of known processes and devices for continuous fluidized bed spray granulation is known from Uhlemann, Chem.-Ing.-Tech. 62 (1990) p. 822-834.

The disadvantage of the known processes for producing anhydrous alkali sulfide is the poor heat exchange and exchange of materials and the formation of a dust-generating product.

An object of the present invention is to provide a process wherein an anhydrous, non-dust-generating, granular product is formed and the heat exchange and exchange of materials are better than in the known processes.

### SUMMARY OF THE INVENTION

According to the present invention a process is carried out for producing anhydrous alkali sulfide, by drying hydrous alkali sulfide by means of fluidized bed spray granulation.

For example, Na2S *×H2O (3≦×≦9) can be used as the hydrous alkali sulfide. The hydrous alkali sulfide can be introduced into the process chamber as a melt, suspension, dispersion or solution.

The alkali sulfide solution, alkali sulfide suspension, alkali sulfide dispersion or alkali sulfide water of crystallisation melt can be introduced into the process chamber with a solids content of 10% <xsolids<95%, preferably 20%<xsolids<70%, particularly preferably 40%<Xsolids<70%. The alkali sulfide solution can be a solution of alkali sulfide in water.

In the fluidized bed spray granulation process solids particles newly formed in the process chamber or additionally introduced into the process chamber from outside can be fluidized in a fluidized bed by means of a fluidizing gas stream. One side of the process chamber, preferably the base, can be formed by a gas-permeable floor through which the fluidizing gas flows in. The nature of the fluidizing gas can be adjusted by upstream process stages such that it has a potential to cool or to dry. In addition, the fluidizing gas or parts thereof can enter into desired chemical reactions with the solids that are formed or with the solvents that are introduced.

The fluidization rate, which results from the fluidizing gas stream, can preferably be chosen such that the loosening point of the solids bed that is present is exceeded, permitting a continuous transposition of the solids particles. This continuous transposition can give rise to a uniform impact probability for the droplets sprayed in. The amount of energy supplied to or removed from the system can be proportional to the fluidizing gas stream. The fluidizing gas stream can be increased in order to raise the process throughput. Provided that the fluidization rate is less than the particle discharge rate, a stable fluidized bed can be formed. The fluidization rate can be raised further, however, in order to increase further the supply or removal of energy.

Melts, suspensions, dispersions or solutions of alkali sulfides can be sprayed in the process chamber, the droplets of which are deposited on the fluidized particles and disperse on their surface. The transfer of heat from the gas stream to the wet particles can cause the solvent to evaporate, leaving the dissolved, dispersed or suspended solid in a thin layer on the particle. This can result in a shell-type build-up of solid material on the surface of the particles. The particle growth described here can be influenced by the material properties, such as e.g. solids density, adhesive tendency and fluidizing behaviour, and controlled by a suitable choice of process parameters so that it is reproducible.

The fluidizing gas can be a heated, oxygen-free inert gas, which takes up evaporating solvent as it passes through the fluidized bed and removes it from the process. The fluidizing gas can be nitrogen, helium, argon or a mixture of the cited gases.

The fluidizing gas can have a temperature of 250° C. to 800° C. inside the process chamber.

The solution, suspension, dispersion or melts can be sprayed using nozzles through which one or more substances can be passed simultaneously. They can take the form of pressure nozzles or pneumatic atomizers. If pressure nozzles are used, only the pressurised solutions, suspensions, dispersions or melts of the substance to be granulated can be sprayed. If on the other hand pneumatic atomizers are used, atomizing gas and nozzle cleaning gas can be sprayed in addition to the liquid substances from solutions, suspensions, dispersions or melts. The technical design of the nozzles or the direction of flow through the nozzles into the fluidized bed chamber can in principle be freely chosen and depends on the product. The maximum number of substances that can be fed through a nozzle should in no way restrict the granulation of alkali sulfides. The auxiliary gas used for atomization can be an oxygen-free inert gas. In the gas recycling operation a split stream of the recycled gas can preferably be used.

A split stream of granules can be removed continuously or discontinuously from the granulation fluidized bed, optionally cooled and if necessary stored under a protective gas atmosphere or packed. The granulation can also be performed batchwise.

If a stable fluidized bed is used, on leaving the fluidized bed the exhaust gas can carry with it a proportion of fine dust, which can be separated off by suitable means, using filters or cyclones for example, and returned to the fluidized bed. The extensive separation of dust can take place above the fluidized bed in the fluidized bed spray granulator itself or outside the spray granulator in a suitable external separator. If surface filters with pressure surge cleaning are used for dust separation, cleaning can be performed with any oxygen-free gas, but preferably with preheated inert gas or a split stream of the fluidizing gas.

The process according to the invention can be performed under excess pressure, normal pressure or partial vacuum. A preferred process pressure range can exist if granules conforming to specification are produced with the fluidizing gas at the maximum permissible system temperature and at maximum capacity. Since the introduction of oxygen into the system must be avoided, the plant can preferably be operated under normal pressure or slight overpressure of Δp=0 to 200 mbar above ambient pressure.

### BRIEF DESCRIPTION OF DRAWINGS

The present invention will be further understood with reference to the accompanying drawings, wherein:

FIG. 1 is a schematic flow diagram of the spray drying of alkali sulfide in a press-through process, and

FIG. 2 is a schematic flow diagram of the spray drying of alkali sulfide in a gas recycling process.

### DETAILED DESCRIPTION OF INVENTION

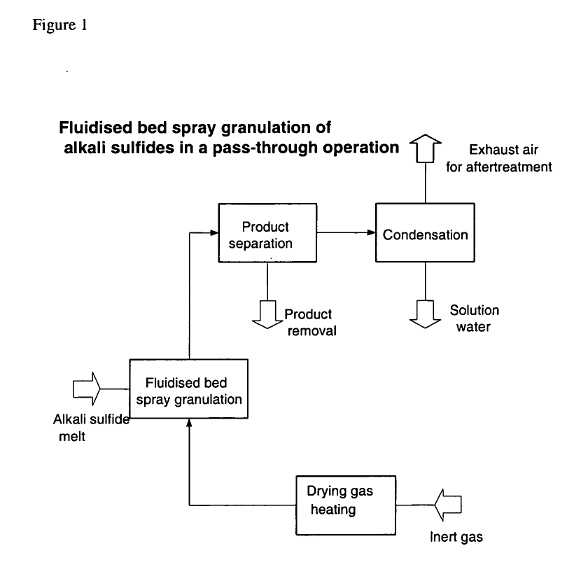

The process according to the invention can be performed in a pass-through operation as shown in FIG. 1.

In the pass-through operation inert gas can be heated as the fluidizing gas. The fluidizing gas can preferably be a low-oxygen gas containing less than 0.1 vol. %, preferably less than 0.05 vol. %, oxygen or an oxygen-free gas. The fluidizing gas heaters can be operated electrically, with steam or with heat transfer media. A combination of fluidizing gas heaters may be convenient in order to run the drying plant economically.

The fluidizing gas can then be used to spray the alkali sulfide solution, alkali sulfide suspension, alkali sulfide dispersion or alkali sulfide water of crystallization melt into the fluidized bed granulation apparatus.

The drying gas can flow through the chamber at a gas speed that is sufficient to at least fluidize the particle bed or even to remove partially dried or agglomerated particles pneumatically.

The particles conveyed by the drying gas stream can be separated from the gas stream and optionally at least partially recycled (fine dust recycling). The particles whose size is within the desired particle size range can be removed from the chamber, preferably continuously, so that the mass inside the chamber remains constant.

The solvent can be condensed and the exhaust air aftertreated.

In the pass-through operation, fresh fluidizing gas is continually fed into the process chamber and the exhaust gas leaving the process chamber is discarded.

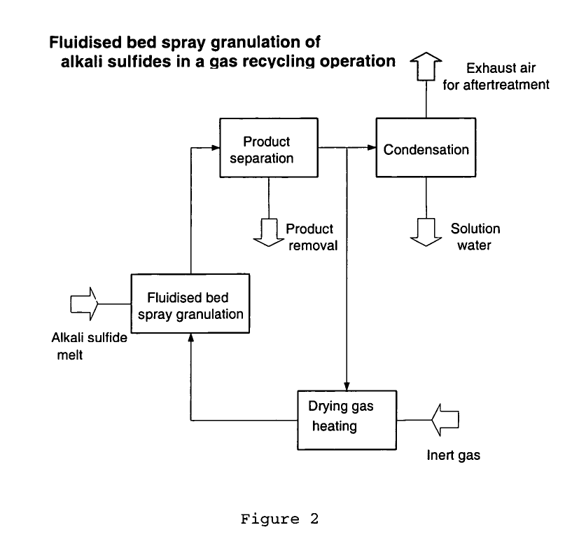

The process according to the invention can be performed in a gas recycling operation as shown in FIG. 2, wherein the exhaust gas can be recycled and conditioned by energy input in such a way that it can be used again as the fluidizing gas. During conditioning, the liquid components evaporated in the process chamber can be partially removed again from the exhaust gas such that they too can be recycled. As complete as possible a gas recycling with removal of the excess solvents and inert gases is desirable from an economic perspective. In the gas recycling operation the solvent vapours can gradually accumulate in the pure inert gas that is used. After some time an equilibrium fluidizing gas composition can become established, which is determined by the proportion of inert gas additionally introduced and by the proportion of evaporating solvents.

The water vapour-containing exhaust gas can be discarded or the water vapour preferably condensed. The gas can be conditioned again for use as the fluidizing gas.

In the preferred process as shown in FIG. 2, that is, avoiding the additional introduction of inert gases into the ongoing process, drying can take place in stationary operation in pure superheated water vapour, whereby the quantity of water sprayed in the process chamber can be removed. The water vapour-containing exhaust gas can be discarded or the water vapour preferably condensed. The gas can be conditioned again for use as the fluidizing gas. In the stationary process the use of inert gases can be largely, preferably completely, avoided such that drying and granulation are performed in virtually pure, superheated water vapour. With this mode of operation an aftertreatment of the possibly odorous exhaust gas can be avoided altogether.

The anhydrous alkali sulfide produced with the process according to the invention can contain a residual water content of less than 10 wt. %, preferably less than 3 wt. %, particularly preferably less than 2 wt. %.

The anhydrous alkali sulfides produced with the process according to the invention can be alkali sulfide granules.

The granules produced with the process according to the invention can have an average particle size distribution of 100 μm to 30 mm. The granules can be approximately spherical, solid solids particles.

At the start of the granulation process an inert starter filler, for example silica sand, can be used. This inert starter filler can act as a carrier to which the alkali sulfide is applied.

In batchwise operation part of the granules produced in this way can be reused as the starter filler. The inert material in the original starter filler can thus be gradually removed. A correlation can exist here between the resulting granule size and the ratio by mass of starter filler to applied alkali sulfide.

In continuous operation the inert starter filler can be gradually removed.

As a consequence of the preferable avoidance of the use of inert gases in stationary operation, no pollutant-containing inert gas, which would be difficult to clean, can be formed.

The advantage of the process according to the invention is that it displays a greater heat exchange and exchange of materials than the known spray drying process and hence a greater efficiency. The process according to the invention can lead to granular, non-dust-developing products having substantially better handling properties, such as e.g. lower potential risk.

The invention also provides a device for performing the process according to the invention, which includes the following components:

a granulator chamber with a diameter-height ratio of 1:1 to 1:5, having a feed base,

an atomizing device installed in this chamber for the melts, suspensions, dispersions or solutions,

a feed device for the fluidizing and drying medium,

a discharge outlet located in the upper part of the chamber for the fine dusts or particles to be recycled,

a solids separation system connected to the chamber via this discharge outlet and having an exhaust air pipe optionally fitted with a filter unit to remove the gas stream,

a return system for the fine dusts and products to be recycled, which leads from the discharge outlet to the lower part of the chamber,

an air separator located in the lower part of the chamber,

a plant for recovering the solvent from the exhaust gas stream

a recycling and conditioning apparatus for at least partial recycling and conditioning of the exhaust gas for renewed use as the fluidizing gas (gas recycling operation).

### EXAMPLES

Na2S * 3H2O is melted in a glass vessel at a temperature of 120° C. The resulting melt has a water content of approximately 41%. A gear pump is used to convey the melt to the dryer. The melt is sprayed into the dryer using a two-fluid nozzle (Schlick 970-S4) with a nozzle diameter of 1.2 mm. The nozzle is operated at a gas pressure of 3 bar with an atomising gas flow rate of 4.5 m3/h.

The fluidized bed granulator that is used consists of a drying chamber with a diameter of 190 mm and a height of 370 mm. The base of the drying chamber acts as a gas distributor. Fine dust is returned to the fluidized bed via a cyclone and a filter. A water-operated washer is used for additional cleaning of the exhaust gas stream.

The drying gas is heated using an electric gas heater. Nitrogen and water vapour from the water distribution system are used as the drying gas. The water vapour is depressurised from 10 bar to atmospheric pressure, passed through a condensation product separator and then superheated. The drying gas is supplied to the drying chamber at a temperature of up to 400° C.

In the drying chamber is a starter filler onto which the melt is sprayed. The starter filler consists of 500 g silica sand with a particle size of 200 to 350 μm. The heat input from the drying gas causes the solvent to evaporate (water of crystallisation). Drying takes place at an exhaust gas temperature of between 150 and 250° C., the mass flux of the melt controlling the outlet temperature of the drying gas. The gas stream leaving the drying chamber passes through the cyclone and the filter, where entrained particles are separated off.

The operation is performed batchwise, and following the end of the experiment the dry product is removed from the fluidized bed. The particle size of the product is around 300 to 550 μm. The sprayed mass of sodium sulfide corresponds to around 1500 g. Larger particles are formed by splitting the amount of product and reusing it as the starter filler. As a result the silica sand is ultimately removed.

The apparatus components are manufactured from glass and from stainless steel.

The setting parameters and residual moisture are set out in Table 1.

TABLE 1

| Parameter | Unit | Example 1 | Example 2 | Example 3 |
|---|---|---|---|---|
| Drying gas stream | m³/h | 100 | | |
| Atomising gas | m³/h | 4.5 | | |
| Medium | | Nitrogen | Nitrogen | Water vapour |
| Inlet temperature | ° C. | 300 | 400 | 400 |
| Exhaust gas temperature | ° C. | 150 | 250 | 250 |
| Residual moisture | % | 7.5 | 1.5 | 2.5 |

The cited residual moisture contents relate only to sodium sulfide; the inert starter filler was left out of the calculation.

The examples from the process according to the invention display a residual moisture below 10 wt. %. The sodium sulfide obtained, produced with the process according to the invention, is non-dust-generating and granular.

Determining the residual moisture:

19.5 g Na₂S*xH₂O is weighed into a 1000 ml measuring flask, dissolved in demineralized water and the flask topped up to the calibration mark. Of this solution either precisely 10 ml are pipetted off or 10.0 g weighed out using a precision balance into a 300 ml Erlenmeyer flask with ground glass stopper and diluted with approximately 90 ml demineralised water from a measuring cylinder. By means of a Metrohm Dosimat 60 ml iodine solution (0.05 mol/litre) are pipetted in with gentle stirring using a magnetic stirrer, during which process the solution becomes turbid over time due to precipitating sulfur and later turns a brown colour due to the excess of iodine solution. As iodometry is a time reaction, the reaction solution is left to stand for 15 minutes at room temperature, during which time it is shaken frequently. It is stored during this time in the closed flask and if possible in the dark, since iodine is volatile and iodide is oxidized to iodine by the introduction of light.

After this reaction time the excess iodine is titrated with a 0.1 n sodium thiosulfate solution. During the titration normal solution is first added until the solution just turns brown due to the iodine present. After addition of 2 ml starch solution (blue color), titration is continued until the color changes and the amount of thiosulfate solution consumed is noted. A triple determination is performed on each dissolved sample.

### Calculation

The sodium sulfide reacts with iodine in the molar ratio 1:1. For the titration of 10.0 g of an Na₂S solution obtained from 19.5 g Na₂S (100%) in 1000 ml H₂O, exactly 50.0 ml of an iodine solution with c=0.05 mol/litre are consumed. With an initial quantity of 60.0 ml iodine solution, a further 10.0 ml must be back-titrated with 10.0 ml sodium thiosulfate solution c =0.1 mol/litre. The active ingredient content and then the water content of the Na₂S used are then calculated from the increase in consumption of sodium thiosulfate solution using the formula below:

$$\frac{( V ( {I}_{2} ) - V ( {Na}_{2} {S}_{2} {O}_{3} ) ) * 0.05 mol \text{/} l * M ( {Na}_{2} S )}{Weighed amount of {Na}_{2} S [ g ]} * 100 * 100 = Active ingred . content in wt . \%$$

V(I₂)=Initial volume of iodine solution in liters

V(Na₂S₂O ₃)=Consumption of sodium thiosulfate solution in litres

M(Na₂S)=Molecular weight of sodium sulfide in g/mol

m(Na₂S)=Weighed amount of Na₂S sample in g

Residual moisture in wt. %=100—active ingredient content in wt. %.

Further variations and modifications of the foregoing will be apparent to those skilled in the art and are intended to be encompassed by the claims appended hereto.

German priority application 102 56 530.9 is relied on and incorporated herein by reference.

1. Process for producing anhydrous alkali sulfide, comprising drying hydrous alkali sulfide by fluidized bed spray granulation.

2. Process for producing anhydrous alkali sulfide according to claim 1, wherein drying is performed under normal pressure or a slight overpressure of Δp=0 to 200 mbar above ambient pressure.

3. Process for producing anhydrous alkali sulfide according to claim 1, further comprising recycling the fluidizing gas and removing excess water vapour by condensation so that it is free from exhaust gases.

4. The process for producing anhydrous alkali sulfide according to claim 1, wherein the hydrous alkali sulfide is selected from the group consisting of alkali sulfide solution, alkali sulfide suspension, alkali sulfide dispersion and alkali sulfide water of crystallization melt.

5. The process for producing anhydrous alkali sulfide according to claim 4, wherein drying is performed under normal pressure or a slight overpressure of Δp=0 to 200 mbar above ambient pressure with an inert gas.

6. The process for producing anhydrous alkali sulfide according to claim 4, further comprising recycling the fluidizing gas and removing excess water vapour by condensation so that it is free from exhaust gases.

7. A device for performing the process according to claim 1, comprising the following components:
a granulator chamber with a diameter-height ratio of 1:1 to 1:5, having a feed base,
an atomizing device installed in said chamber for the melts, suspensions, dispersions or solutions,
a feed device for the fluidizing and drying medium,
a discharge outlet located in the upper part of the chamber for the fine dusts or particles to be recycled,
a solids separation system connected to the chamber via said discharge outlet and having an exhaust air pipe optionally fitted with a filter unit to remove the gas stream,
a return system for the fine dusts and products to be recycled, which leads from the discharge outlet to the lower part of the chamber,
an air separator located in the lower part of the chamber,
a plant for recovering the solvent from the exhaust gas stream
a recycling and conditioning apparatus for at least partial recycling and conditioning of the exhaust gas for renewed use as the fluidizing gas.
